(19) United States
(12) Patent Application Publication
(10) Pub. No.: US 2009/0001831 A1
(43) Pub. Date: Jan. 1, 2009

(54) Axial Field Electric Motor and Method

(76) Inventors: Chahee P. Cho, Carmel, IN (US); Chong O. Lee, Madison, AL (US)

Correspondence Address: NAVAL UNDERSEA WARFARE CENTER;DIVISION NEWPORT, 1176 HOWELL STREET, CODE 000C, NEWPORT, RI, 02841, US

(21) Appl. No.: 11/768,258

(22) Filed: Jun. 26, 2007

(51) Int. Cl. H02K 21/12; H02K 15/03

(52) U.S. Cl. 310/112; 29/598; 310/156.36

(57) ABSTRACT

A hybrid field, brushless, permanent magnet electric motor utilizing a rotor with two sets of permanent magnets oriented such that the flux produced by the two sets of magnets is perpendicular to each other. A plurality of axial flux permanent magnets are positioned radially interiorly of a plurality of radial flux permanent magnets. Axial stators interact with the axial flux permanent magnets. A radially positioned stator interacts with radial flux permanent magnets. In one configuration, an electronic feedback system is created that magnetically clamps and holds the hybrid rotor in its axially centrally aligned position, thereby reducing axial vibrations.

### STATEMENT OF GOVERNMENT INTEREST

The invention described herein may be manufactured and used by or for the Government of the United States of America for governmental purposes without the payment of any royalties thereon or therefore.

### BACKGROUND OF THE INVENTION

(1) Field of the Invention

The present invention relates generally to electric motors and, more specifically, to vibrations in axial field electrical motors.

(2) Description of the Prior Art

The basic configuration of a brushless, permanent magnet, axial field electrical motor 10 is illustrated in FIG. 1A and FIG. 1B. In the figures, axial stators 12 and 14 axially surround a rotor 16. The stators 12 and 14 provide a rotating magnetic field, and are positioned on opposite axial ends of rotor permanent magnets 24. A rotor shaft 28 extends through stator openings 31 in the stators 12 and 14. The typical stator 12 comprises stator teeth 18 that define stator slots 20 wherein stator windings, such as a representative stator winding 22 are positioned.

The rotor 16 of the axial field motor 10 comprises a plurality of permanent rotor magnets 24 secured together by rotor retaining ring 26. The permanent rotor magnets 24 alternate in magnetic polarity wherein the magnetic flux is directed axially. Rotor magnet dividers 25 comprise a structure or frame of the rotor 16 that comprises pockets and the magnet dividers for holding and separating the permanent magnets. The rotor dividers 25 and the rotor frame may be comprised of materials such as aluminum, laminates, non-magnetic material, additional back iron, or other materials. The permanent rotor magnets 24 are secured around rotor back iron 30, which surrounds the rotor shaft 28. It will be appreciated that the number of permanent magnets and/or windings may vary as desired for a particular application.

A representative radial field, brushless, permanent magnet electric motor 36 is shown in FIG. 4A and FIG. 4B, and comprises a motor housing 38 and a rotor shaft 40. FIG. 4B is a cross-section that illustrates a rotor 42 radially surrounded by radial stator 44. The radial stator 44 comprises a stator back iron 48, stator teeth 50, stator slots 52, and windings 54 positioned within the stator slots. The rotor 42 of the radial field motor 36 comprises a plurality of rotor permanent magnets 56, which alter in magnetic polarity, and are secured to a rotor back iron 58 by a retaining ring 60. Direction arrows marked on the magnets 56 indicate a radially oriented and alternating magnetic flux direction.

Axial field electric motors are suitable for use in high power density power applications. However, axial field motors may be associated with axial vibrations, which may produce warping effects, variations in diameter, and the like, as illustrated schematically in dash in FIG. 2. Radial vibrations may also occur due to variations such as eccentricity of the rotor as illustrated schematically in dash in FIG. 3. The radial vibrations can be reduced by utilizing bearings around the rotor shaft. However, axial vibration due to axial movement of the rotor shaft 28 with respect to the motor housing 38 is not reduced by such bearings.

The following U.S. patents references describe various prior art systems that may be related to the above and/or other axial field, brushless, permanent rotor magnet systems:

U.S. Pat. No. 4,441,043, issued Apr. 3, 1984, to DeCesare, discloses a dynamoelectric machine of the type having a distributed armature winding in a cylindrical rotor wound to form axial and substantially radial winding portions and including permanent and/or electromagnets to form radial and axial air gaps between the rotor and the stator, and to provide interaction between the magnetic field in the radial air gap and the axial rotor winding portions and to provide interaction between the magnetic fields in the axial air gaps and the essentially radially rotor winding portions.

U.S. Pat. No. 4,567,391, issued Jan. 28, 1986, to Tucker et al, discloses an electric motor in which armature coils are included in a stator and permanent magnets are included in a rotor. The armature coils are disposed substantially radial to the axis of the stator with the axial extent of each coil lesser than the radial extent of each coil, and the permanent magnets of the rotor are disposed substantially radially to the axis of rotation of the rotor with the axial extent of each permanent magnet lesser than the radial extent of each permanent magnet. A three phase switching circuit excites the armature coils to impart rotation to the rotor.

U.S. Pat. No. 4,683,388, issued Jul. 28, 1987, to DeCesare, discloses a dynamoelectric machine of the type having a distributed armature winding in a cylindrical rotor wound to form axial and substantially radial winding portions and including permanent and/or electromagnets to couple magnetic flux into the peripheral or circumferential surface of the rotor, and to provide interaction between a magnetic field formed beyond the rotor axial surfaces and the rotor to thereby enhance the total induction of flux into the rotor.

U.S. Pat. No. 5,200,659, issued Apr. 6, 1993, to Clarke, discloses an adjustable speed drive system which employs a unique induction machine that includes a rotor assembly mounted on a shaft, and associated cooperative first and second stators. The two stators are angularly adjustable, relative to each other, about the axis of the shaft. The net excitation of the rotor and thus the operating point of the machine on the torque-speed curve of a load on the shaft of the machine is a function of the relative angular displacement of the two stators. A third stator may be employed to enhance the efficiency of the machine by feeding excess rotor power back into the power line.

The prior art cited above does not disclose the proposed solution of the present invention. Consequently, those ordinarily skilled in the art will appreciate the present invention that addresses the above and other problems.

### SUMMARY OF THE INVENTION

It is therefore a general purpose and primary object of the present invention to provide an improved axial field electric motor.

It is a further object of the present invention is to provide an improved electric motor for high power density applications.

These and other objects, features, and advantages of the present invention will become apparent from the drawings, the descriptions given herein, and the appended claims. However, it will be understood that above listed objects and advantages of the invention are intended only as an aid in understanding certain aspects of the invention, are not intended to limit the invention in any way, and do not form a comprehensive or exclusive list of objects, features, and advantages.

Accordingly, the present invention provides an electric motor hat comprises one or more elements such as a rotor mounted for rotation and a plurality of axial flux permanent magnets carried by the rotor. The plurality of axial flux permanent magnets is oriented such that an associated magnetic flux produced thereby is at least substantially axially oriented.

The plurality of axial flux permanent magnets are positioned around the rotor with alternating orientations of flux direction such that a flux direction of adjacent magnets is at least substantially axially oriented but opposite in direction.

A plurality of radial flux permanent magnets are also carried by the rotor and oriented such that an associated magnetic flux produced thereby is at least substantially radially oriented.

The plurality of radial flux permanent magnets may be positioned around the rotor with alternating orientations of flux direction such that a flux direction of adjacent magnets is at least substantially radially oriented but opposite in direction.

A first axial stator and a second axial stator are positioned on axially opposite sides of the plurality of axial flux permanent magnets. The first axial stator and the second axial stator comprise a plurality of axial stator windings oriented for interacting with the plurality of axial flux permanent magnets. Other elements may comprise a radial stator positioned radially around the rotor that may comprise a plurality of radial stator windings oriented for interacting with the plurality of radial flux permanent magnets. In one embodiment of the electric motor, at least a portion of the radial stator windings may be oriented with respect to the plurality of radial flux permanent magnets to produce at least one axially directed force on the rotor.

In another embodiment, at least a portion of the plurality of radial stator windings may be oriented to produce a first axial force acting on the rotor and a second axial force acting on the rotor. The first axial force and the second axial force are opposite in direction and acting to prevent axial vibration of the rotor. The electric motor may further comprise a first radial stator winding positioned adjacent a first axial side of the rotor and a second radial stator winding positioned adjacent a second axial side of the rotor. A feedback system is thereby produced such that as the rotor moves axially away from the first radial stator winding, then the first axial force decreases, whereby the second axial force urges the rotor to move axially back toward the first radial stator winding. The same happens as the rotor moves axially away from the second radial stator winding. Thus, the feedback system thereby acts to centralize the rotor between the first radial stator winding and the second radial stator winding.

The electric motor may comprise at least a portion of the plurality of radial stator windings being oriented in a direction transverse, perpendicular, or orthogonal to an axis of rotation of the rotor. The electric motor may comprise at least a portion of the plurality of radial stator windings being oriented in a direction parallel or substantially parallel to an axis of rotation of the rotor.

The present invention may also provide a method for making an electric motor that comprises one or more steps such as mounting a rotor in a motor housing for rotation therein and/or mounting on the rotor a plurality of axial flux permanent magnets oriented, such that an associated magnetic flux produced thereby is at least substantially axially oriented. Other steps may comprise mounting on the rotor a plurality of radial flux permanent magnets oriented such that an associated magnetic flux produced thereby is at least substantially radially oriented and/or positioning the plurality of radial flux permanent magnets on the rotor radially outwardly from the plurality of axial flux permanent magnets. Other steps may comprise mounting to the motor housing a first axial stator and a second axial stator on axially opposite sides of the plurality of axial flux permanent magnets and providing the first axial stator and the second axial stator with a plurality of axial stator windings oriented for interacting with the plurality of axial flux permanent magnets.

The method may further comprise mounting to the motor housing a radial stator positioned radially around the rotor and providing the radial stator with a plurality of radial stator windings for interacting with the plurality of radial flux permanent magnets.

In one embodiment, the method may further comprise positioning a first radial stator winding adjacent a first axial side of the rotor and a second radial stator winding adjacent a second axial side of the rotor. As the rotor moves axially away from the first radial stator winding, then a first axial force decreases, whereby a second opposing axial force urges the rotor to move axially back toward the first radial stator winding, thereby acting to centralize the rotor between the first radial stator winding and the second radial stator winding. Other steps may comprise orienting a least a portion of the plurality of radial stator windings in a direction transverse to an axis of rotation of the rotor, and/or orienting at least a portion of the plurality of radial stator windings in a direction parallel to an axis of rotation of the rotor.

### BRIEF DESCRIPTION OF THE DRAWINGS

A more complete understanding of the invention and many of the attendant advantages thereto will be readily appreciated as the same becomes better understood by reference to the following detailed description when considered in conjunction with the accompanying drawings, wherein like reference numerals refer to like parts and wherein:

FIG. 1A is an exploded perspective view depicting the configuration of a prior art brushless axial field motor;

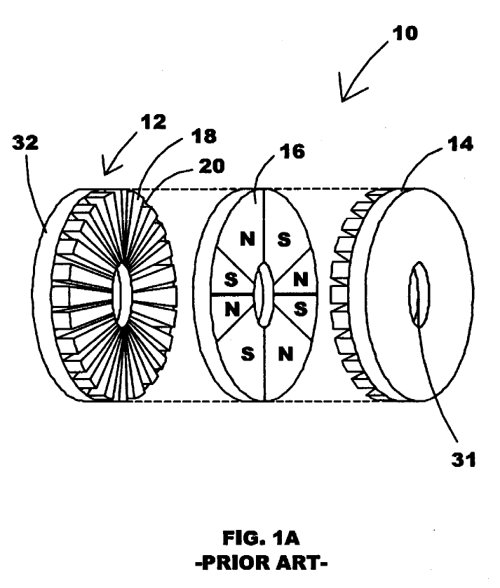

FIG. 1B is a view taken transverse to a rotor axis depicting a rotor and a stator of a prior art axial field motor;

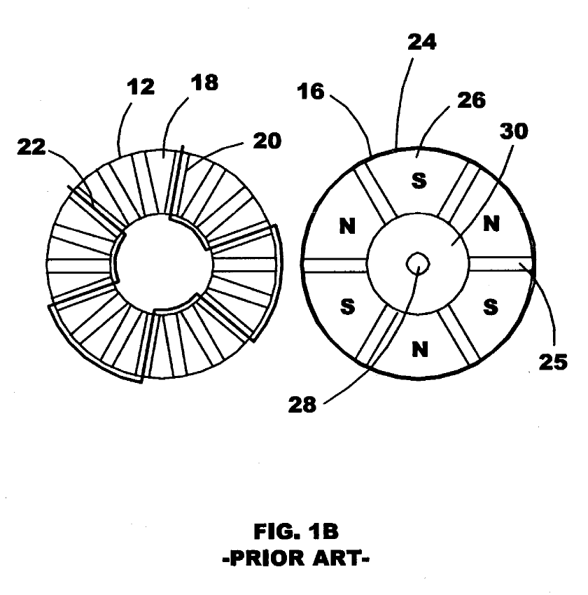

FIG. 2 is a view taken parallel to the rotor axis depicting a schematic, partially in section and dash, that illustrates a prior art rotor warping effect causing axial vibration;

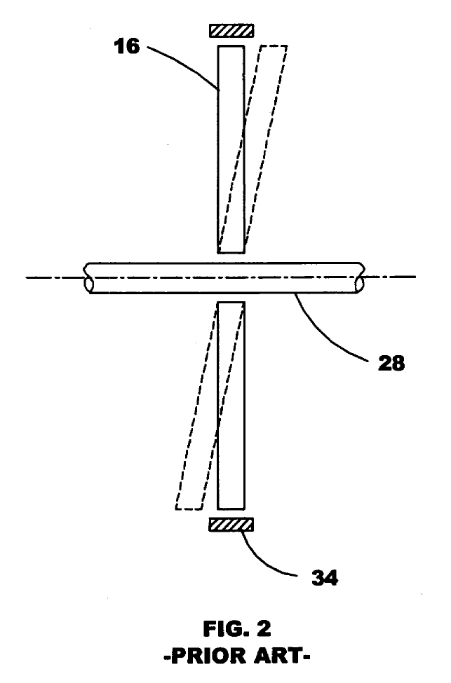

FIG. 3 is a view taken parallel to the rotor axis depicting a schematic, partially in section and dash, that illustrates a prior art rotor radial vibration or eccentricity;

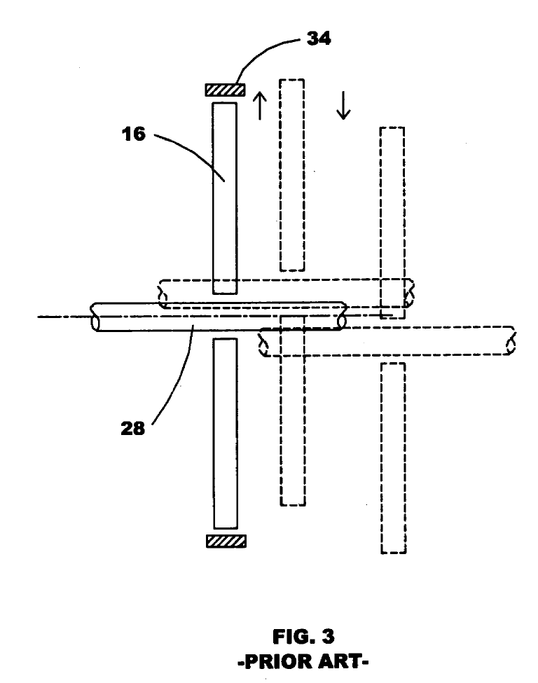

FIG. 4A is a perspective view of a prior art radial field, brushless, permanent magnet motor;

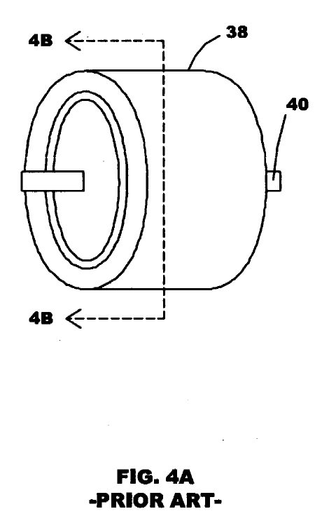

FIG. 4B is a view taken perpendicular to the rotor axis along reference lines 4B-4B in FIG. 4A, partially in cross-section, of a radial field, brushless, permanent magnet motor;

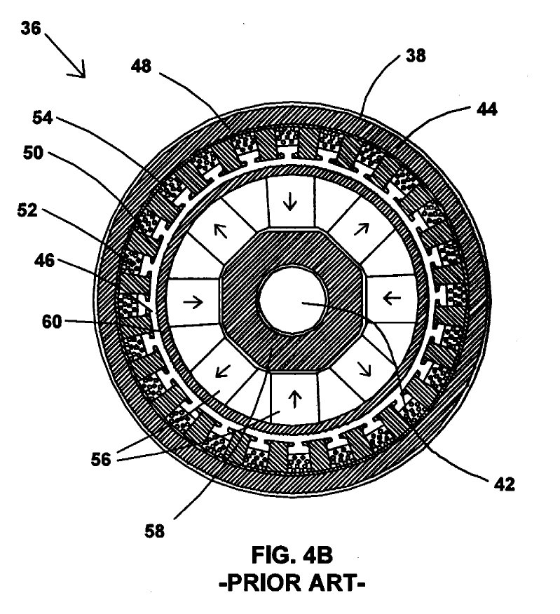

FIG. 5 is a view taken perpendicular to the rotor axis, partially in cross-section, showing a possible hybrid motor configuration in accordance with the present invention;

FIG. 6 is a view taken parallel to the rotor axis, partially in cross-section, depicting a schematic of an upper portion of a hybrid motor configuration in accordance with the present invention;

FIG. 7 is a view in accordance with the present invention taken parallel to the rotor axis showing a schematic that illustrates a feedback system in accordance with one embodiment of the present invention to counteract the rotor warping effect that causes axial vibration;

FIG. 8 is a view in accordance with the present invention taken parallel to the rotor axis showing a schematic that illustrates a feedback system in action in accordance with one embodiment of the present invention to counteract the rotor warping effect that causes axial vibration; and

FIG. 9 is a view taken perpendicular to the rotor axis, partially in cross-section, depicting a possible hybrid motor configuration.

### DETAILED DESCRIPTION OF THE INVENTION

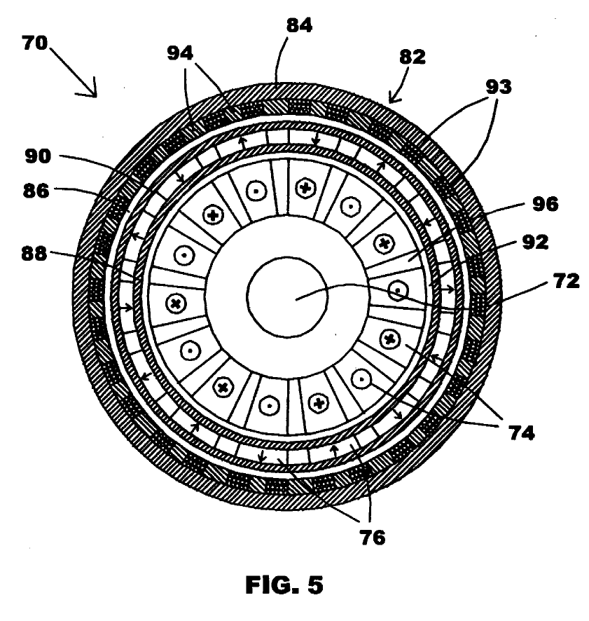

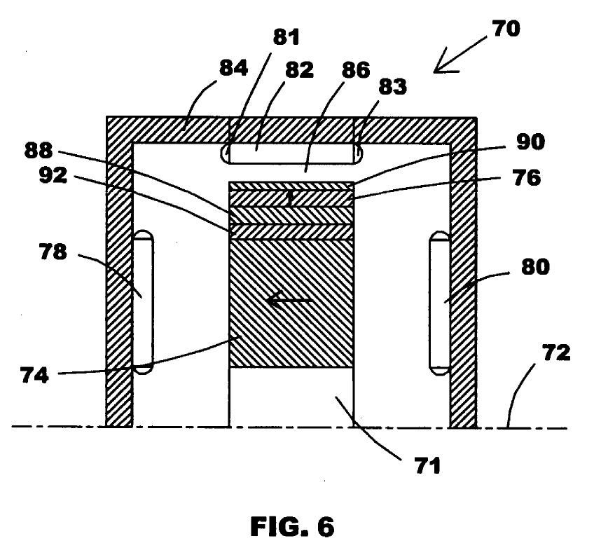

Referring now to the drawings, and more particularly to FIG. 5, there is depicted a cross-sectional view of one embodiment of a hybrid field, brushless, permanent magnet electric motor 70 in accordance with the present invention. In the embodiment of the hybrid electric motor 70, a hybrid rotor is produced that magnetically interacts with both radial and axial magnetic fields. FIG. 6 depicts the orientation of axial stators 78 and 80 and a radial stator 82 with respect to a hybrid rotor 71.

Returning to FIG. 5, the figure depicts a cross-section of the hybrid electric motor 70 taken perpendicular to rotor shaft 72 of the motor rotor. It will be seen that there are a plurality of axial flux permanent magnets 74 with alternating and opposite directions of axially directed magnetic flux. The circle with a dot indicates magnetic flux coming out of the cross-section of FIG. 5 and the circle with a cross indicates flux going into the cross-section.

The radial stator 82 comprises teeth 94, a back iron 84 and windings 93. The teeth and windings may be oriented parallel to the rotor shaft 72, generally parallel, or may be angled with respect to rotor axis 92.

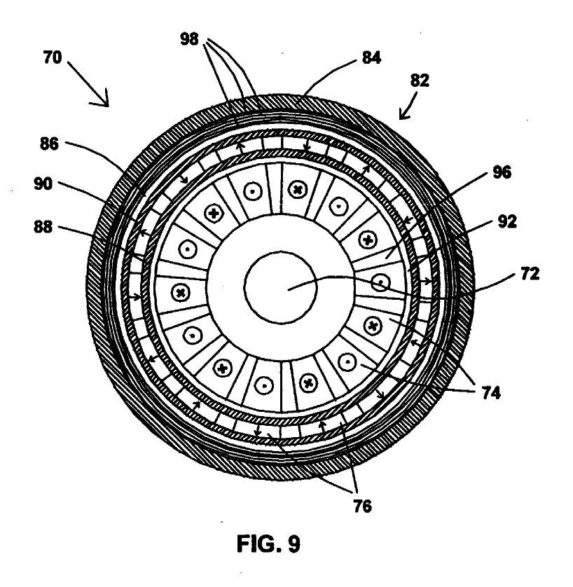

FIG. 9 depicts a substantially identical rotor, but provides an embodiment of the present invention wherein stator windings 98 are arranged so as to run perpendicular to the shaft 72.

Returning now to FIG. 6, the figure depicts an upper cross-sectional schematic view of the hybrid electric motor 70 wherein, as already shown in FIG. 5 and Fla. 9, the hybrid rotor shaft 72 supports the plurality of axial flux permanent magnets 74 and a plurality of radial flux permanent magnets 76. The axial stators 78 and 80, with associated stator windings as discussed before, are positioned on axially opposite sides of and interact with the axial flux permanent magnets 74 on the hybrid rotor shaft 72. The radial stator 82 is radially positioned around the hybrid rotor 71 to interact with radial flux permanent magnets 76.

In one embodiment of the present invention, radial stator windings 81 and 83 may be positioned so as to be substantially adjacent opposite axial front and rear sides of the hybrid rotor 71 to thereby maximize forces that counteract axial vibration, as discussed below. A hybrid motor housing 84 provides support and/or stator back iron for the radial stator 82 and the axial stators 78 and 80. A radial air gap 86 is defined between the radial stator 82 and the hybrid rotor 71. A rotor back iron 88 is positioned radially between the axial flux permanent magnets 74 and the radial flux permanent magnets 76. A retaining ring 90 surrounds the hybrid rotor 71 and holds the components of the hybrid rotor together. A structure 92 may comprise a non-magnetic separator and/or rotor structure such as an aluminum structure for the hybrid rotor 71 that defines pockets for the permanent magnets and radial spacers 96 (see FIG. 5). Alternatively, the structure 92 and spacers 96 may be comprised of separate components, laminates, and the like.

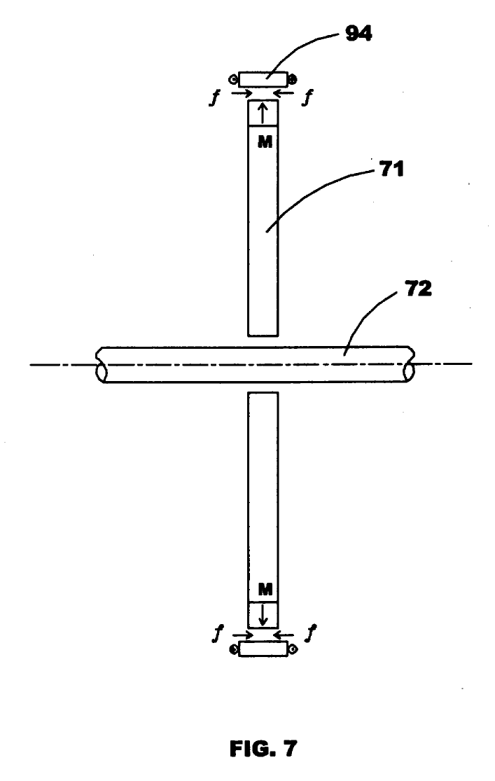

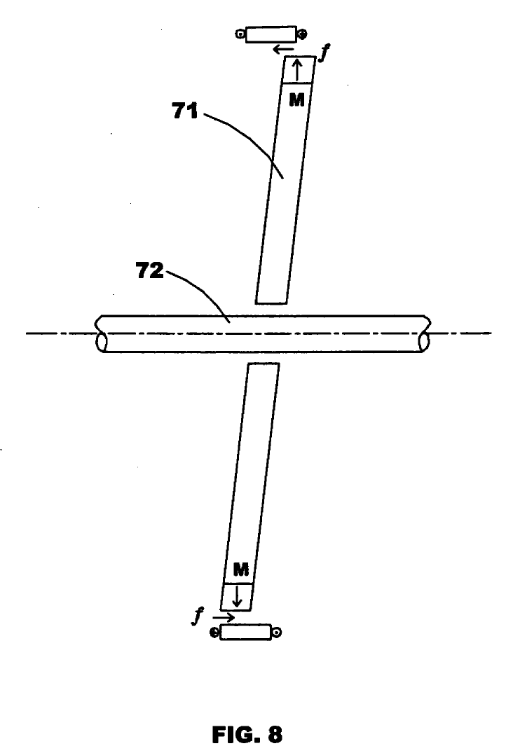

As shown in FIG. 7 and FIG. 8, the present invention may be utilized to create an electromagnetic feedback system that magnetically clamps and holds the rotor in its centrally aligned position, thereby reducing axial vibrations. The cross-sectional view of FIG. 7 and FIG. 8 is similar in orientation as that of FIG. 6. In this embodiment, stator windings may be substantially perpendicular to the axis of the rotation of the hybrid rotor shaft 72. As shown in FIG. 7, it will be appreciated that with the magnetic flux directed radially, either inwardly or outwardly, and with electron current in the direction as indicated either into the page or out of the page, then two forces will be produced in opposite directions as indicated by the two sets of arrows shown on opposite radial ends of the hybrid rotor 71. These forces both act toward the hybrid rotor 71 and thereby act to hold the hybrid rotor in a centralized position. This can be verified using the motor rule or right-hand rule with thumb, forefinger and middle finger oriented orthogonally. If the forefinger is the direction of magnetic flux, the middle is the direction of electron current, and then the force so produced will be in the direction of the thumb. Moreover as indicated in FIG. 8, if the hybrid rotor 71 attempts to warp, then the force produced on one side of the rotor will be greater than that produced in the opposite direction; thereby, tending to push the hybrid rotor back into a vertical position and thereby reducing axial vibrations produced due to warping or bending of the rotor. The feedback or centralizing effect will be greatest if the wires in the radial stator winding are oriented to be substantially perpendicular to the rotor axis 72, and positioned as shown in FIG. 5 so that the stator windings 81 and 83 are adjacent axially opposite sides of the radial flux permanent magnets 76.

If the orientation of stators windings is parallel to the hybrid rotor shaft 72 or the axis thereof, then the stator windings produce a force that increases torque applied to the hybrid rotor 71. It will be appreciated when the stator windings are at angles between parallel and perpendicular with respect to the rotor shaft 72, that some feedback effects will be produced to reduce axial vibrations and some amount of force will be provided to increase torque of the hybrid rotor 71. Thus, the orientation of the stator windings can be selected as desired with these benefits in mind.

In summary, the present invention provides a hybrid field, brushless, permanent magnet electric motor 70. The hybrid rotor shaft 72 supports two different sets of permanent magnets oriented such that their flux is perpendicular to each other. In a preferred embodiment, the plurality of axial flux permanent magnets 74 and the plurality of radial flux permanent magnets 76 are utilized. The axial stators 78 and 80, with associated stator windings as discussed before, axially surround the axial flux and interact with the axial flux permanent magnets 74 on the hybrid rotor shaft 72. The radial stator 82 radially surrounds and interacts with the radial flux permanent magnets 76. An electronic feedback system may be created that magnetically clamps and holds the hybrid rotor 71 in an axially centrally aligned positioned thereby reducing axial vibrations.

Many additional changes in the details, components, steps, algorithms, and organization of the system, herein described and illustrated to explain the nature of the invention, may be made by those skilled in the art within the principle and scope of the invention. It is therefore understood that within the scope of the appended claims, the invention may be practiced otherwise than as specifically described.

What is claimed is:

1. An electric motor comprising:
a rotor mounted for rotation;
a plurality of axial flux permanent magnets carried by said rotor, said plurality of axial flux permanent magnets oriented such that an associated magnetic flux produced thereby is at least substantially axially oriented and said plurality of axial flux permanent magnets positioned around said rotor with alternating orientations of flux direction such that a flux direction of adjacent magnets is at least substantially axially oriented but opposite in direction;
a plurality of radial flux permanent magnets carried by said rotor, said plurality of radial flux permanent magnets oriented such that an associated magnetic flux produced thereby is at least substantially radially oriented and said plurality of radial flux permanent magnets positioned around said rotor with alternating orientations of flux direction such that a flux direction of adjacent magnets is at least substantially radially oriented but opposite in direction;
a first axial stator and a second axial stator, said first axial stator and said second axial stator positioned on axially opposite sides of said plurality of axial flux permanent magnets, said first axial stator and said second axial stator comprising a plurality of axial stator windings oriented for interacting with said plurality of axial flux permanent magnets; and
a radial stator positioned radially around said rotor, said radial stator comprising a plurality of radial stator windings oriented for interacting with said plurality of radial flux permanent magnets.

2. The electric motor of claim 1, wherein at least a portion of said plurality of radial stator windings are oriented with respect to said plurality of radial flux permanent magnets to produce at least one axially directed force on said rotor.

3. The electric motor of claim 2, wherein at least a portion of said plurality of radial stator windings are oriented to produce a first axial force acting on said rotor and a second axial force acting on said rotor, said first axial force and said second axial forces being opposite in direction and acting to prevent axial vibration of said rotor.

4. The electric motor of claim 3, further comprising a first radial stator winding positioned adjacent a first axial side of said rotor and a second radial stator winding positioned adjacent a second axial side of said rotor, such that as said rotor moves axially away from said first radial stator winding then said first axial force decreases whereby said second axial force urges said rotor to move axially back toward said first radial stator winding thereby acting to centralize said rotor between said first radial stator winding and said second radial stator winding.

5. The electric motor of claim 1, wherein at least a portion of said plurality of radial stator windings are oriented in a direction transverse to an axis of rotation of said rotor.

6. The electric motor of claim 1, wherein at least a portion of said plurality of radial stator windings are oriented in a direction parallel to an axis of rotation of said rotor.

7. A method for making an electric motor comprising:
mounting a rotor in a motor housing for rotation therein;
mounting on the rotor a plurality of axial flux permanent magnets oriented such that an associated magnetic flux produced thereby is at least substantially axially oriented;
mounting on the rotor a plurality of radial flux permanent magnets oriented such that an associated magnetic flux produced thereby is at least substantially radially oriented and positioning the plurality of radial flux permanent magnets on the rotor radially outwardly from the plurality of axial flux permanent magnets;
mounting to the motor housing a first axial stator and a second axial stator on axially opposite sides of the plurality of axial flux permanent magnets and the providing the first axial stator and the second axial stator with a plurality of axial stator windings oriented for interacting with the plurality of axial flux permanent magnets; and
mounting to the motor housing a radial stator positioned radially around the rotor and providing the radial stator with a plurality of radial stator windings for interacting with the plurality of radial flux permanent magnets.

8. The method of claim 7, orienting at least a portion of the radial stator windings with respect to the plurality of radial flux permanent magnets to produce at least one axially directed force on the rotor.

9. The method of claim 7, orienting at least a portion of the plurality of radial stator windings to produce a first axial force acting on the rotor and an oppositely directed second axial force acting on the rotor to resist axial vibration of the rotor.

10. The method of claim 9, further comprising positioning a first radial stator winding adjacent a first axial side of the rotor and a second radial stator winding adjacent a second axial side of the rotor such that as the rotor moves axially away from the first radial stator winding, then the first axial force decreases whereby the second axial force urges the rotor to move axially back toward the first radial stator winding, thereby acting to centralize the rotor between said the radial stator winding and the second radial stator winding.

11. The method of claim 7, further comprising orienting at least a portion of the plurality of radial stator windings in a direction transverse to an axis of rotation of said rotor.

12. The method of claim 7, further comprising orienting at least a portion of the plurality of radial stator windings in a direction parallel to an axis of rotation of the rotor.
